(19) United States
(12) Patent Application Publication
(10) Pub. No.: US 2001/0049907 A1
(43) Pub. Date: Dec. 13, 2001

(54) Fuel reforming apparatus and method

(75) Inventor: Masahiro Inoue, Gotenba-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, TOYOTA-SHI (JP)

(21) Appl. No.: 09/871,806

(22) Filed: Jun. 4, 2001

(30) Foreign Application Priority Data
Jun. 8, 2000 (JP) 2000-172396

(51) Int. Cl. C10J 3/50; B01F 3/02; C10K 3/06

(52) U.S. Cl. 48/76; 48/78; 48/127.9; 48/180.1

(57) ABSTRACT

A fuel reforming apparatus includes a vaporizing device, a vapor mixing device and a reforming device. The vaporizing device produces a vapor by vaporizing at least a portion of a first one of a hydrocarbon fuel and water, without mixing with a second one of the hydrocarbon fuel and the water, so as to produce a vapor gas containing the vapor and air. The vapor mixing device receives the vapor gas from the vaporizing device, and creates a vapor mixture by spraying at least a portion of at least one of the hydrocarbon fuel and the water, which was not vaporized by the vaporizing device, toward the supplied vapor gas. Thr reforming device receives the vapor mixture from the vapor mixing device and reforms the hydrocarbon fuel to a reformate gas containing hydrogen. The temperature of the vapor gas supplied to the vapor mixing device can be adjusted such that the temperature of the reformate source gas supplied to the reforming device falls within a temperature range corresponding to an operating temperature of the reforming device. Vapor mixing the fuel immediately prior to supplying it to the reforming device enables a pre-reaction of the reformate source gas to be inhibited.

### INCORPORATION BY REFERENCE

The disclosure of Japanese Patent Application No. 2000-172396 filed on Jun. 8, 2000, including the specification, drawings and abstract is incorporated herein by reference in its entirety.

### BACKGROUND OF THE INVENTION

1. Field of Invention

The invention relates to a fuel reforming apparatus and method, and more particularly to a fuel reforming apparatus and method in which a reforming device reforms hydrocarbon fuel to a reformate gas containing hydrogen.

2. Description of Related Art

A conventional example of this type of fuel reforming apparatus is disclosed in Japanese Patent Laid-Open Publication No. 11-79703, in which is proposed an apparatus for vaporizing a portion of a fuel-water mixture to be reformed and spraying another portion of the fuel-water mixture. With this apparatus, a portion of the mixture of water and liquid hydrocarbon such as gasoline or liquid hydrocarbon fuel such as methanol to be reformed is vaporized by a vaporizer and supplied to a reformer, while another portion of the fuel-water mixture is sprayed from a spray nozzle into vapor produced by the vaporizer to create a vapor mixture which is then supplied to a reformer. The vaporized and mixed fuel-water mixture to be reformed is then reformed to a hydrogen rich gas by the reformer. Configuring the apparatus in this way improves responsiveness to changes in load and also improves vaporization performance of the fuel-water mixture to be reformed.

With this type of fuel reforming apparatus, however, an unexpected reaction (pre-reaction) may be generated within the vaporizer and at the supply flow passage to the reformer of the fuel-water mixture to be reformed due to the vaporization of the fuel-water mixture by the vaporizer. When gasoline is used as the hydrocarbon fuel, the temperature of the mixed gas supplied to the reformer is around 400 to 500° C. Although it depends somewhat on the reforming catalyst used in the reforming device, it is assumed that the temperature of the mixed gas supplied approximates the operating temperature of the reforming portion. Accordingly, raising the temperature of the fuel-water mixture to be reformed in the vaporizer to within this temperature range tends to facilitate the pre-reaction of the fuel-water mixture to be reformed within the vaporizer and at the flow passage to the reforming portion. A pre-reaction of the fuel-water mixture to be reformed may inhibit a desired reaction in the reformer and therefore lead to lower reforming efficiency.

### SUMMARY OF THE INVENTION

It is an object of the invention to inhibit the pre-reaction of the fuel-water mixture to be reformed in a step prior to its supply to the reforming device in the fuel reforming apparatus.

It is another object of the invention to reduce the size of the fuel reforming apparatus.

It is still another object of the invention to improve the responsiveness to a change in load in the fuel reforming apparatus.

It is yet another object of the invention to improve the reforming efficiency of the fuel reforming apparatus.

The fuel reforming apparatus according to one aspect of the invention employs some or all of the following structure to achieve some or all of the foregoing objects.

A fuel reforming apparatus includes a reforming device, a vaporizing device (a vaporizer) and a vapor mixing device. The reforming device reforms a hydrocarbon fuel to a reformate gas containing hydrogen. The vaporizing device produces a vapor by vaporizing at least a portion of a first liquid selected from the hydrocarbon fuel and water without mixing with a second liquid, which is the other of the hydrocarbon fuel and water, so as to produce a vapor gas containing the vapor and air. The vapor mixing device receives a supply of the vapor gas from the vaporizing device, creates a vapor mixture by spraying at least a portion of at least one selected from the first liquid and the second liquid, which is not vaporized by the vaporizing device, toward the supplied vapor gas, and supplies the vapor mixture which is a mixed gas to the reforming device.

With the fuel reforming apparatus of this aspect of the invention, at least a portion of either one of a hydrocarbon fuel and water is vaporized with the vaporizing device. This prevents an unexpected reaction from being generated by the hydrocarbon fuel and water in the middle of vaporization. Moreover, liquid which has not been vaporized by the vaporizing device is sprayed toward the mixing region of the vapor and air supplied to a vapor mixing device, and the mixed gas which has been vapor mixed is supplied to the reforming device as the mixed gas to be reformed. As a result, it is possible to reduce the size of the vaporizing device compared with apparatus in which the vaporizing device vaporizes all of the liquid. Further, mixing the hydrocarbon fuel, water, and air immediately before they are supplied to the reforming device prevents an unexpected reaction from being generated before they are supplied to the reforming device. This enables a desired reforming reaction to take place in the reforming device and improves reforming efficiency in the apparatus. It is also possible to easily adjust the supply quantity of the liquid of either the fuel or the water to be sprayed in the vapor mixing device, which can improve responsiveness with respect to a change in load. Included herein are cases in which the liquid is a hydrocarbon fuel, a portion of one of the liquids of either hydrocarbon fuel or water is vaporized, a portion or all of the hydrocarbon fuel is vaporized without the water being vaporized, and a portion or all of the water is vaporized without the hydrocarbon fuel being vaporized. Also included are such cases in which the hydrocarbon fuel is a gas and a portion of the water is vaporized.

In one type of fuel reforming apparatus of one aspect of the invention, the vaporizing device vaporizes at least a portion of water selected as the first liquid, and the vapor mixing device sprays the hydrocarbon fuel selected as the second liquid that is not vaporized by the vaporizing device. With such a configuration, the hydrocarbon fuel is sprayed and mixed with the water vapor to create a vapor mixture immediately before being supplied to the reforming device, which further inhibits a pre-reaction from occurring in the mixed gas to be reformed before it is supplied to the reforming device.

Moreover, in the fuel reforming apparatus of one aspect of the invention, the quantity of liquid sprayed by the vapor mixing device is controllable. This makes it possible to improve responsiveness with respect to a change in load to the apparatus. In this case, the spray device includes a return member that returns a portion of the hydrocarbon fuel which is not vaporized by the vaporizing device to a supply, and a return quantity adjusting device that adjusts the quantity of the hydrocarbon fuel to be returned to the supply by the return member. This enables the spray quantity of the liquid to be sprayed in the vapor mixing device to be adjusted by adjusting the liquid quantity to be returned to the supply side by the return quantity adjusting device.

In the fuel reforming apparatus according to one aspect of the invention, the spray device uses a gas when spraying the at least one liquid selected from the first liquid and the second liquid. In this case, the spray device uses at least a portion of the vapor produced by the vaporizing device. This promotes atomization of the liquid to be sprayed, as well as promotes vapor mixture of the atomized liquid in the mixing region of the vapor and air.

In the fuel reforming apparatus of one aspect of the invention in which water is vaporized by the vaporizing device and the hydrocarbon fuel is sprayed in the vapor mixing device, the water vapor from the vaporizing device may also be used for spraying. Alternatively, the hydrocarbon fuel can be vaporized by the vaporizing device and the water can be sprayed by the spray device.

Moreover, in the fuel reforming apparatus according to one aspect of the invention, the vapor mixing device includes a vapor gas supply quantity adjusting device that adjusts a quantity of the vapor gas produced by the vaporizing device and supplied to the vapor mixing device, and an air supply quantity adjusting device that adjusts a quantity of the air supplied to the vapor mixing device. This enables the supply quantity of vapor and air to be set as desired.

Further, the fuel reforming apparatus according to another aspect of the invention may also include a vapor spray quantity control device that controls a quantity of the at least a portion of the first liquid to be vaporized by the vaporizing device, and a quantity of the at least a portion of the at least one selected from the first liquid and the second liquid sprayed by the spray device. This enables a more appropriate quantity to be vaporized and sprayed. In the fuel reforming apparatus according to this aspect of the invention, the vapor spray quantity control device controls a temperature of the mixed gas to be supplied to the reforming device to fall within a predetermined temperature range. This enables a mixed gas of a more accurate temperature to be supplied to the reforming device. As a result, it is possible to more efficiently generate a reforming reaction in the reforming device. Furthermore in the fuel reforming apparatus according to this aspect of the invention, the predetermined temperature range contains a temperature that is below a lower limit of a regular operating temperature range of the reforming device by a predetermined amount.

In the fuel reforming apparatus according to one aspect of the invention, the vapor mixing device includes a mixture promoting member that promotes mixture of the vapor gas, the gas supplied to the vapor mixing device, and the sprayed liquid. This promotes vapor mixture. In the fuel reforming apparatus according to this aspect of the invention, the mixture promoting member is substantially conical with a through hole in a center thereof, and the vapor mixing device includes the mixture promoting member and a supply port such that the supplied vapor and air are mixed and spurted out from the through hole, and sprays the at least a portion of the at least one selected from the first liquid and the second liquid from the through hole of the mixture promoting member.

### BRIEF DESCRIPTION OF THE DRAWINGS

The invention will be described in detail with reference to the accompanying drawings in which like reference numerals designate like elements and wherein:

FIG. 1 is a block diagram showing an outline of the configuration of a fuel reforming apparatus according to a first embodiment of the invention;

FIG. 2 is a flow chart showing an example of a flow quantity adjustment processing routine executed by an electronic control device of the fuel reforming apparatus in the first embodiment;

FIG. 3 is a graph showing an example of the relationship between a water vapor quantity Qw and an air quantity Qa with respect to a fuel spray quantity Qf;

FIG. 4 is a graph showing an example of changes in the fuel spray quantity Qf, water vapor quantity Qw, and air quantity Qa with respect to change over time of a required load Q*;

FIG. 5 is a block diagram showing an outline of the configuration of a fuel reforming apparatus according to a second embodiment of the invention; and

FIG. 6 is a flow chart showing an example of a flow quantity adjustment processing routine executed by the electronic control device of the fuel reforming apparatus in the second embodiment.

### DETAILED DESCRIPTION OF PREFERRED EMBODIMENTS

First Embodiment

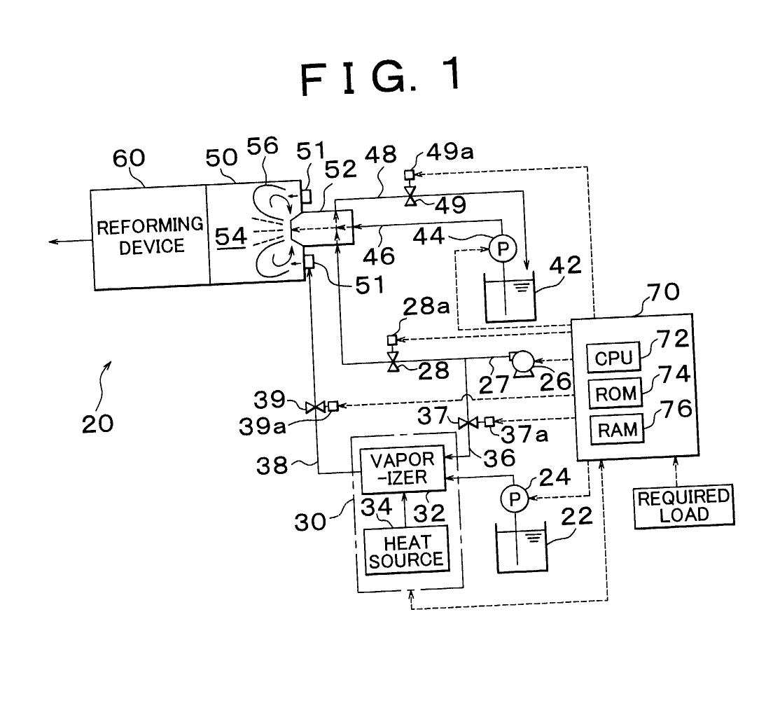

The invention will hereinafter be described with reference to exemplary embodiments of the invention. FIG. 1 is a block diagram showing an outline of the configuration of a fuel reforming apparatus 20 according to a first embodiment of the invention. The fuel reforming apparatus 20 according to this embodiment is provided with a vaporizing device 30, a vapor mixing device 50, a reforming device 60, and an electronic control device (controller) 70 for controlling the entire apparatus. The vaporizing device 30 receives a supply of water from a water tank 22 by a water pump 24, and a supply of air from a blower 26, and supplies water vapor mixed gas composed of water vapor and air. The vapor mixing device 50 receives the supply of water vapor mixed gas from the vaporizing device 30, vaporizes a liquid hydrocarbon fuel (for example, gasoline) sprayed from a spray nozzle 52 toward the supplied water vapor mixed gas, and mixes the two so as to produce a reformate source gas. The reforming device 60 then reforms the source gas supplied from the mixing device 50 to a hydrogen rich reformate gas by a water vapor reforming reaction.

The vaporizing device 30 vaporizes water with a vaporizer 32 which receives heat from a heat source 34, mixes the water vapor with air, and supplies the mixture to the vapor mixing device 50 as a water vapor mixed gas in a superheated state. FIG. 1 schematically shows the vaporizing device 30 composed of the vaporizer 32 and the heat source 34. Alternatively, however, an apparatus may be used in which the vaporizer 32 and the heat source 34 are integrated. For example, a catalytic combustion type vaporizing device may also be used which vaporizes and superheats water using heat obtained from catalytic combustion of supplied fuel. Air is supplied to the vaporizer 32 via a branched pipe 36 that branches off from an air supply pipe 27 from the blower 26. The quantity of air supplied can be adjusted by a flow quantity adjusting valve 37 provided in the branched pipe 36. In addition, the water vapor mixed gas obtained with the vaporizer 32 is supplied to the vapor mixing device 50 via a water vapor supply pipe 38. The supplied quantity of water vapor mixed gas can be adjusted by a flow quantity adjusting valve 39 provided in the water vapor supply pipe 38.

The temperature of the water vapor mixed gas to be supplied from the vaporizing device 30 is adjusted such that the temperature range of the reformate source gas, in which the sprayed hydrocarbon fuel is vapor mixed with the water vapor mixed gas in the vapor mixing device 50, to be supplied to the reforming device 60 becomes approximately 300 to 600° C. The amount of heat required by the change in load also changes, but if the temperature of the water vapor mixed gas to be supplied to the vapor mixing device 50 from the vaporizer 32 is controlled, the temperature of the source gas can be maintained in the above-mentioned temperature range even if there is a change in load. This is because, as will be described later, the water vapor quantity and air quantity necessary for partial oxidation and water vapor reforming of the hydrocarbon fuel to be sprayed from the spray nozzle 52 are roughly proportionate. An operating temperature range for the reforming device 60 of approximately 600 to 1000° C. may efficiently generate a partial oxidation reaction and a water vapor reforming reaction in the reforming device 60. Therefore, the temperature of the source gas to be supplied to the reforming device 60 is set to be within a range of approximately 300 to 600° C. Accordingly, the temperature of the water vapor mixed gas to be supplied to the vapor mixing device 50 from the vaporizer 32 is adjusted such that the temperature range of the source gas becomes approximately 300 to 600° C.

The spray nozzle 52 provided in the vapor mixing device 50 is constructed as a fluid spray nozzle for spraying liquid hydrocarbon fuel using air. The fluid hydrocarbon fuel, which has been pressurized to a predetermined pressure, is supplied to this fluid spray nozzle 52 from a fuel tank 42 by a fuel pump 44 via a fuel supply pipe 46, while pressurized air is also supplied by the blower 26 to this fluid spray nozzle 52 via the air supply pipe 27. A return pipe 48 for communicating with the fuel supply pipe 46 is attached to this spray nozzle 52 so that a portion of the hydrocarbon fuel supplied via the fuel supply pipe 46 can return to the fuel tank 42 via the return pipe 48. A flow quantity adjusting valve 49 is provided in this return pipe 48. Adjusting the opening amount of this flow quantity adjusting valve 49 enables the quantity of spray from the spray nozzle 52 to be adjusted. The supply quantity of air is adjusted by the flow quantity adjusting valve 28 provided in the air supply pipe 27.

A supply port 51 for the water vapor mixed gas is provided on the side to which the spray nozzle 52 is attached in a vapor mixing chamber 54 of the vapor mixing device 50. A substantially conical baffle 56 having a through hole in the center and a wide open portion wrapping around to the outside, a portion of which contacts a wall of the vapor mixing chamber 54, is provided in the vapor mixing chamber 54 so that the spray portion of the spray nozzle 52 is positioned in the through hole in the center. The water vapor mixed gas supplied from the supply port 51 flows, wrapping around along the baffle 56 as shown by the arrows in FIG. 1, and blows out through the center through hole to the side of the reforming device 60. The hydrocarbon fuel being sprayed from the spray nozzle 52 into this water vapor mixed gas that blows out both promotes mixture of the hydrocarbon fuel with the water vapor mixed gas, as well as promotes vaporization of the hydrocarbon fuel.

The electronic control device 70 is constructed as a microprocessor having a CPU 72 as a main constituent, and includes ROM 74 that stores one or more processing programs, RAM 76 that temporarily stores data, and an input/output port (not shown). Into this electronic control device 70 are input signals such as a signal for a temperature showing the operation state of the vaporizing device 30 and the required load Q* to the apparatus and the like via the input port. From the electronic control device 70 are output signals such as driving signals to the water pump 24 and the fuel pump 44 and a driving signal to the blower 26, control signals to the vaporizing device 30, and driving signals to actuators 28a, 37a, 39a, and 49a of flow rate adjusting valves 28, 37, 39, and 49 and the like via the output port.

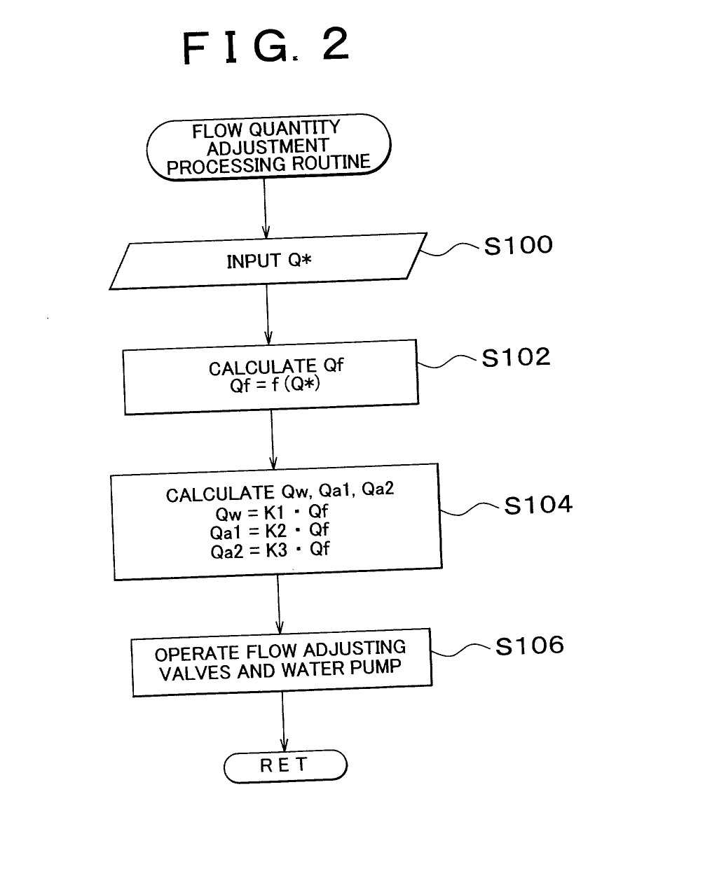

The operation of the fuel reforming apparatus 20 of the embodiment configured in this way will hereinafter be described. FIG. 2 is a flow chart showing one example of a flow rate adjustment processing routine executed by the electronic control device 70 of the fuel reforming apparatus 20 of this embodiment. This routine is executed repeatedly in intervals of a predetermined period of time (for example, every 1 second).

When the flow rate adjustment processing routine is executed, the CPU 72 of the electronic control device 70 performs processing to read the required load Q* in Step S100. The term required load Q* refers to a load required for a fuel reforming apparatus 20 from a system, such as a fuel cell or a hydrogen engine, which receives a supply of hydrogen rich reformate gas from this fuel reforming apparatus 20. When the required load Q* is read, the process proceeds to Step S102 in which the fuel spray quantity Qf to be sprayed from the spray nozzle 52 is calculated based on the required load Q*. The required load Q* represents a supply quantity of the reformate gas to be supplied from the fuel reforming apparatus 20. This supply quantity of reformate gas can then be converted to the supply quantity of hydrocarbon fuel to be supplied to the fuel reforming apparatus 20. Therefore, the fuel spray quantity Qf can be proportionately obtained from the required load Q*.

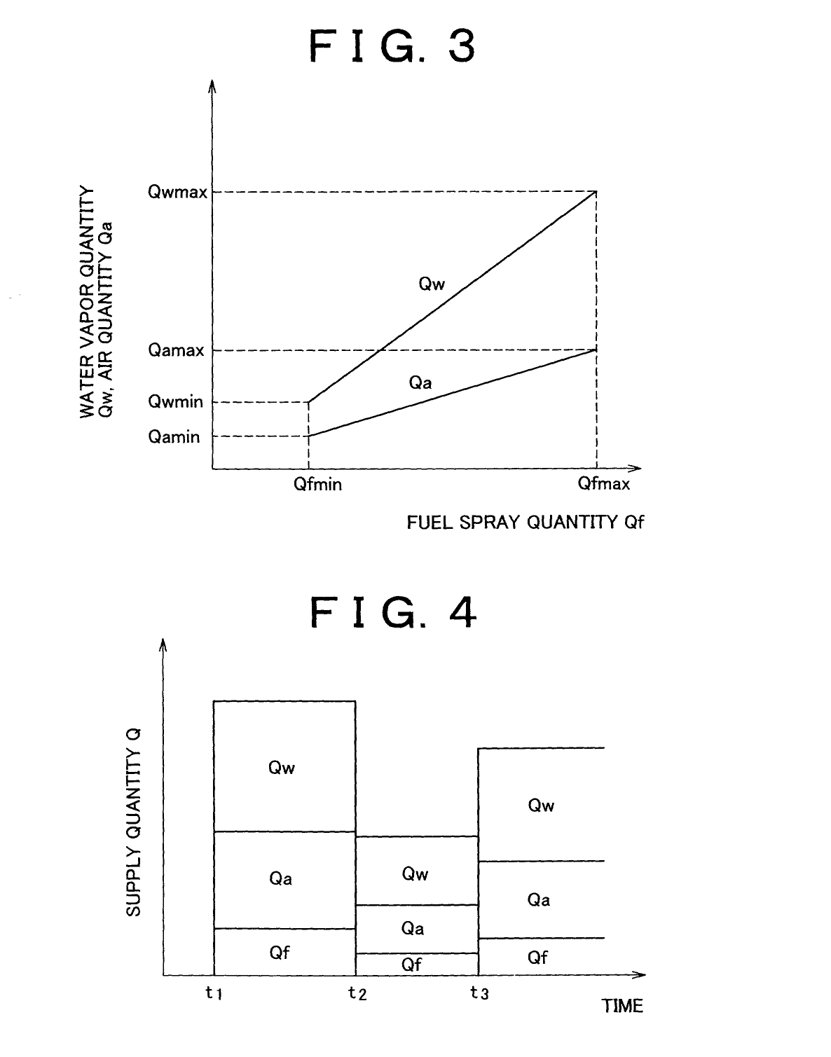

When the fuel spray quantity Qf is calculated in Step S102, the process then proceeds to Step S104 so as to calculate the water vapor quantity Qw and the air quantity Qa necessary for partial oxidation and water vapor reforming of the calculated fuel spray quantity Qf of fuel. In the embodiment, the air quantity Qa1 for fuel spray and the air quantity Qa2 for water vapor are calculated instead of the air quantity Qa. This is because, in the embodiment, air is used in the fuel spray in the spray nozzle 52 and is also supplied to the vaporizer 32. Accordingly, the sum of each of the calculated air quantity Qa1 and Qa2 equals the air quantity Qa. The water vapor quantity Qw and the air quantity Qa are proportionally obtained from the fuel spray quantity Qf. An example of the relationship between the water vapor quantity Qw and the air quantity Qa with respect to the fuel spray quantity Qf is shown in FIG. 3. In FIG. 3, the range defined by the values Qfₘᵢₙ and Qfₘₐₓ of the fuel spray quantity Qf on the horizontal axis shows the range of the spray quantity sprayable from the spray nozzle 52, which is determined by the shape and size of the spray nozzle 52.

When the fuel spray quantity Qf, water vapor quantity Qw, air quantity Qa1, and air quantity Qa2 are obtained in this way, the process proceeds to Step S106. Then the flow quantity adjusting valves 28, 37, 39, and 49 are operated so as to supply the obtained quantities to their respective destinations, while the water pump 24 is driven so as to supply a supply quantity of water that is based on the water vapor quantity Qw to the vaporizer 32, thereby completing the routine.

FIG. 4 is a graph showing an example of the fuel spray quantity Qf, water vapor quantity Qw, and air quantity Qa, which change with a change over time of the required load Q* (i.e., the supply quantity of reformate gas). In FIG. 4, the fuel spray quantity Qf, water vapor quantity Qw, and air quantity Qa obtained based on the required load Q* at time t1 are shown at the time of operation of the fuel reforming apparatus 20. It is apparent from the graph that as the required load Q* becomes smaller at time t2, the fuel spray quantity Qf, water vapor quantity Qw, and air quantity Qa change based on this, and as the required load Q* becomes larger at time t3, the fuel spray quantity Qf, water vapor quantity Qw, and air quantity Qa again change based on this.

In the fuel reforming apparatus 20 of the embodiment described above, liquid hydrocarbon fuel is sprayed toward water vapor mixed gas supplied from the vaporizer 32. It is vaporized, mixed with the water vapor mixed gas, and supplied to the reforming device 60. That is, the hydrocarbon fuel is vaporized and mixed with the water vapor mixed gas immediately before it is supplied to the reforming device 60. This inhibits a pre-reaction that may be generated before the source gas is supplied to the reforming device 60. As a result, it is possible to achieve a desired reforming reaction in the reforming device 60 and improve the reforming efficiency of the apparatus. Furthermore in the fuel reforming apparatus 20 of the embodiment, having only water vaporized with the vaporizer 32 enables the vaporizing device 30 to be smaller in size than when both water and liquid hydrocarbon fuel are vaporized together.

Moreover, in the fuel reforming apparatus 20 of this embodiment, having the spray quantity of the hydrocarbon fuel from the spray nozzle 52 be adjustable increases the responsiveness with respect to a change in load. In addition, with the fuel reforming apparatus 20 of this embodiment, the fact that source gas is of a temperature in a range in accordance with the operating temperature of the reforming device 60 makes it possible to generate a reforming reaction efficiently (the temperature of the source gas supplied to the reforming portion 60 is set in accordance with the operating temperature thereof, allowing efficient reforming reaction). Also, with the fuel reforming apparatus 20 according to this embodiment, the baffle 56 attached to the vapor mixing chamber 54 of the vapor mixing device 50 promotes mixing of the sprayed hydrocarbon fuel and the water vapor mixed gas and vaporization of the hydrocarbon fuel. This in turn enables the vapor mixing device 50 to be smaller in size.

Second Embodiment

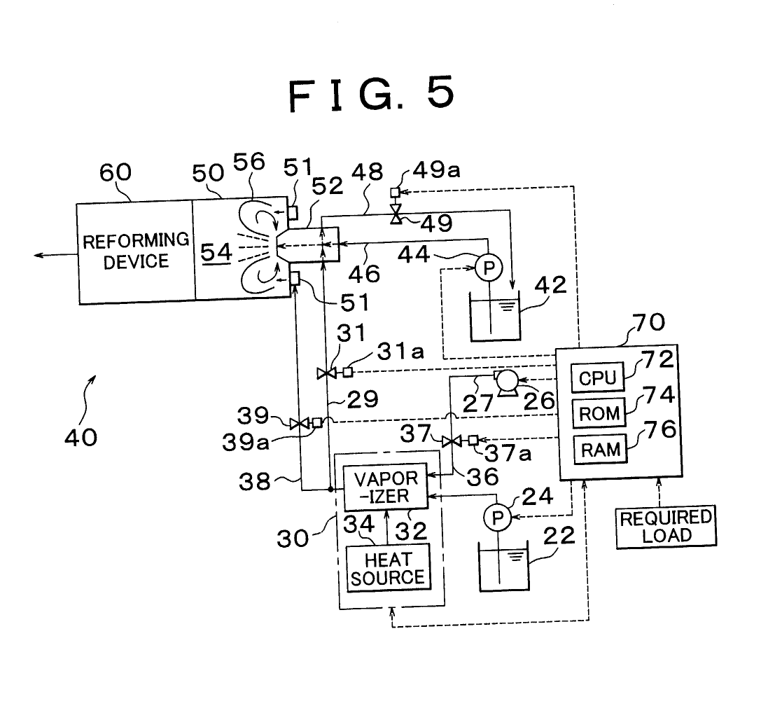

A fuel reforming apparatus 40 according to a second embodimentof the invention will hereinafter be described. FIG. 5 is a block diagram showing an outline of the configuration of the fuel reforming apparatus 40 according to the second embodiment. The fuel reforming apparatus 40 of the second embodiment as shown in FIG. 5 is identical to the fuel reforming apparatus 20 of the first embodiment except that water vapor mixed gas from the vaporizer 32 is used instead of air supplied from the blower 26 when liquid hydrocarbon fuel is sprayed from the spray nozzle 52. Accordingly, reference characters and the descriptions thereof pertaining to the configuration of the fuel reforming apparatus 40 in the second embodiment which are identical to those of the configuration of the fuel reforming apparatus 20 in the first embodiment will be omitted.

The water vapor mixed gas is supplied to the spray nozzle 52 via a branching pipe 29, which branches from the water vapor supply pipe 38. Using this water vapor mixed gas, the liquid hydrocarbon fuel is sprayed toward the vapor mixing chamber 54 of the vapor mixing device 50. The supply flow rate of the water vapor mixed gas to be supplied to the spray nozzle 52 is adjusted by a flow control valve 31 provided in the branching pipe 29. The opening of this flow control valve 31 is adjusted by an actuator 31a driven based on a driving signal output from the output port of the electronic control device 70. With the fuel reforming apparatus 20 according to the first embodiment, the air from the blower 26 was supplied to the spray nozzle 52 via the air supply pipe 27. Meanwhile, with the fuel reforming apparatus 40 according to the second embodiment, all of the air from the blower 26 is supplied to the vaporizer 32 because the water vapor mixed gas is supplied via the branching pipe 29.

Just as with the fuel reforming apparatus 20 of the first embodiment, with the fuel reforming apparatus 40 of the second embodiment, the temperature of the water vapor mixed gas to be supplied to the vapor mixing chamber 54 from the vaporizing device 30 is adjusted such that the temperature of the source gas when the hydrocarbon fuel sprayed by the vapor mixing device 50 vaporizes, mixes with the water vapor mixed gas, and is supplied to the reforming device 60, becomes within a range of approximately 300 to 600° C.

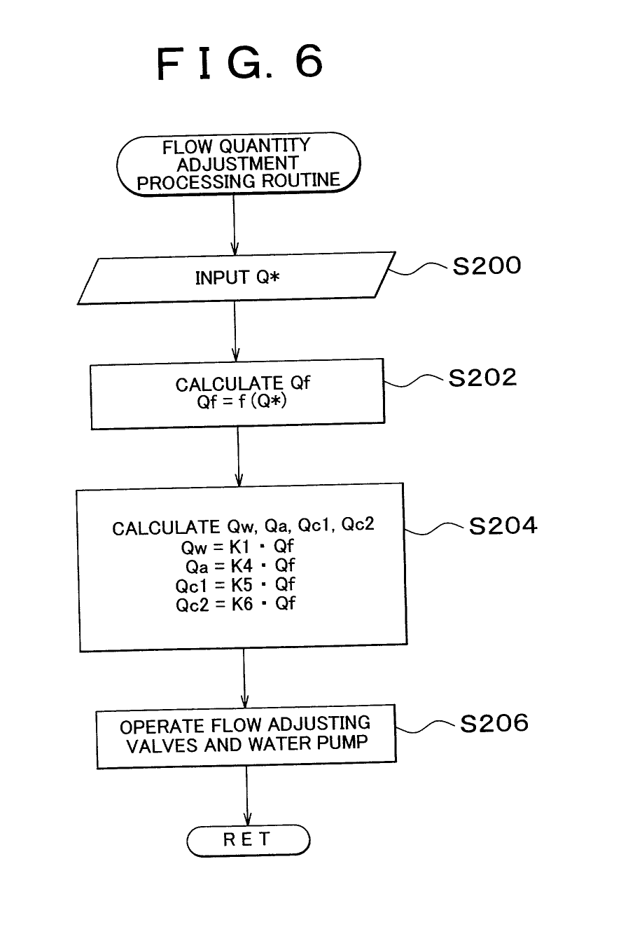

The electronic control device 70 of the fuel reforming apparatus 40 according to the second embodiment configured in this way executes a flow quantity adjustment processing routine illustrated by an example shown in FIG. 6. This routine is identical, with the exception of the processing in Step S204, to the flow quantity adjustment processing routine illustrated by the example shown in FIG. 2 which is executed by the electronic control device 70 of the fuel reforming apparatus 20 according to the first embodiment. It is executed at intervals of a predetermined period of time (for example, every 1 second).

When this routine is executed, the fuel reforming apparatus 40 according to the second embodiment reads the required load Q* in Step S200. Then in Step S202, the fuel spray quantity Qf is calculated based on the read required load Q*. Next in Step S204, the water vapor quantity Qw, air quantity Qa, a vapor supply quantity Qc1 for fuel spray which represents the quantity of water vapor mixed gas supplied to the spray nozzle 52, and a vapor supply quantity Qc2 which is the quantity of water vapor mixed gas supplied to the vapor mixing device 50 are calculated based on the calculated fuel spray quantity Qf. The calculations for the water vapor quantity Qw and the air quantity Qa are identical as those described in the first embodiment. The vapor supply quantity Qc1 for fuel spray represents the amount of water vapor mixed gas that needs to be supplied to the spray of the fuel spray quantity Qf of fuel by the spray nozzle 52, and is obtained based on the fuel spray quantity Qf. The entire supply quantity of water vapor mixed gas is expressed as the sum of the water vapor quantity Qw and the air quantity Qa. The vapor supply quantity Qc2 is obtained by subtracting the fuel spray vapor supply quantity Qc1 from the entire supply quantity of the water vapor mixed gas. Therefore, the sum of the vapor supply quantity Qc1 and the vapor supply quantity Qc2 for fuel spray is equal to the sum of the water vapor quantity Qw and the air quantity Qa. When the water vapor quantity Qw, air quantity Qa, vapor supply quantity Qc1 for fuel spray, and vapor supply quantity Qc2 are calculated in this way, the process proceeds to Step S206 where the flow control valves 31, 37, 39, and 49 are operated so as to supply the calculated quantities to their respective destinations, and the water pump 24 is driven so as to supply a quantity of water based on the water vapor quantity Qw to the vaporizer 32. The routine, thus, is completed.

According to the fuel reforming apparatus 40 of the second embodiment described above, the liquid hydrocarbon fuel is sprayed using the water vapor mixed gas from the vaporizer 32 instead of air from the blower 26. This enables atomization of the hydrocarbon fuel that is to be sprayed, as well as promotes vaporization of the hydrocarbon fuel. The effects obtained with the fuel reforming apparatus 20 according to the first embodiment, i.e., the effects of inhibiting a pre-reaction, improving reforming efficiency, reducing the size of the apparatus, being able to respond to changes in load, and so forth, also are obtained with the fuel reforming apparatus 40 of this embodiment as well.

With the fuel reforming apparatus 20 according to the first embodiment and the fuel reforming apparatus 40 according to the second embodiment, the liquid hydrocarbon fuel is sprayed from the spray nozzle 52. However the liquid hydrocarbon fuel and a portion of water may be sprayed using a spray nozzle capable of spraying a plurality of liquids. In this case, they may be sprayed using air or using the water vapor mixed gas from the vaporizer 32.

Further, with the fuel reforming apparatus 20 according to the first embodiment and the fuel reforming apparatus 40 according to the second embodiment, the water is vaporized with the vaporizing device 30, while the liquid hydrocarbon fuel is sprayed from the spray nozzle 52. Alternatively, however, the liquid hydrocarbon fuel may be vaporized with the vaporizing device 30 while the water is sprayed from the spray nozzle 52.

Moreover, with the fuel reforming apparatus 20 according to the first embodiment and the fuel reforming apparatus 40 according to the second embodiment, a liquid hydrocarbon fuel was used, for example, gasoline; however a gaseous hydrocarbon fuel such as methane or ethane may also be used. In this case, a portion of water to be supplied is vaporized with the vaporizing device 30 while the remaining water is sprayed from the spray nozzle 52, and the gaseous hydrocarbon fuel may be supplied directly to the vapor mixing device 50. In this case, the ratio of the water to be sprayed to the water to be vaporized by the vaporizing device 30 may be arbitrarily set. However, it is preferable to set the aforementioned ratio based on the temperature of the water vapor mixed gas to be supplied to the vapor mixing device 50 from the vaporizer 32. Specifically, it may be set based on the temperature of the water vapor mixed gas in which the temperature of the source gas when it is supplied to the reforming device 60 falls within the above-described temperature range (approximately 300 to 600° C.). In this case as well, the water may be sprayed using air or the water may be sprayed using the water vapor mixed gas. Alternatively, the water may be sprayed using the gaseous hydrocarbon fuel.

With the fuel reforming apparatus 20 according to the first embodiment and the fuel reforming apparatus 40 according to the second embodiment, the temperature of the water vapor mixed gas to be supplied from the vaporizer 32 is set such that the temperature of the source gas to be supplied to the reforming device 60 from the vapor mixing device 50 falls within a temperature range (approximately 300 to 600° C.) suitable for the operating temperature (approximately 600 to 1000° C.) of the reforming device 60. The temperature of the water vapor mixed gas to be supplied from the vaporizer 32, however, does not have to be set such that the temperature of the reformate source gas falls within the temperature range suitable for the operating temperature of the reforming device 60.

With the fuel reforming apparatus 20 according to the first embodiment and the fuel reforming apparatus 40 according to the second embodiment, a baffle 56 is provided in the vapor mixing chamber 54 of the vapor mixing device 50 to promote the vaporization and mixture of the liquid hydrocarbon fuel sprayed into the water vapor mixed gas. It is to be understood, however, that the baffle 56 does not have to be provided.

In the fuel reforming apparatus 20 according to the first embodiment, the fuel reforming apparatus 40 according to the second embodiment and in the above-described modifications thereof, gasoline is used as the liquid hydrocarbon fuel, while methane and ethane are used as the gaseous hydrocarbon fuels. It is to be understood that the liquid hydrocarbon fuel is not limited to gasoline, but various types of liquid hydrocarbon fuels can be used such as liquid saturated hydrocarbon and unsaturated hydrocarbon and alcohols such as methanol and ethanol at normal temperature. It is also to be understood that the gaseous hydrocarbon fuel is not limited to methane and ethane, but various types of gaseous hydrocarbon fuels can be used such as saturated hydrocarbons such as propane and butane gasses and unsaturated hydrocarbons such as ethylene and propylene at normal temperature.

In the illustrated embodiment, the controller (the electronic control device 70) is implemented as a programmed general purpose computer. It will be appreciated by those skilled in the art that the controller can be implemented using a single special purpose integrated circuit (e.g., ASIC) having a main or central processor section for overall, system-level control, and separate sections dedicated to performing various different specific computations, functions and other processes under control of the central processor section. The controller can be a plurality of separate dedicated or programmable integrated or other electronic circuits or devices (e.g., hardwired electronic or logic circuits such as discrete element circuits, or programmable logic devices such as PLDs, PLAs, PALs or the like). The controller can be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the procedures described herein can be used as the controller. A distributed processing architecture can be used for maximum data/signal processing capability and speed.

While the invention has been described with reference to preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

What is claimed is:

1. A fuel reforming apparatus comprising:
a vaporizing device that produces a vapor by vaporizing at least a portion of a first one of a hydrocarbon fuel and water, without mixing with a second one of the hydrocarbon fuel and the water, so as to produce a vapor gas containing the vapor and air;
a vapor mixing device that receives the vapor gas from the vaporizing device, and creates a vapor mixture by spraying at least a portion of at least one of the hydrocarbon fuel and the water, which was not vaporized by the vaporizing device, toward the supplied vapor gas; and
a reforming device that receives the vapor mixture from the vapor mixing device and reforms the hydrocarbon fuel to a reformate gas containing hydrogen.

2. A fuel reforming apparatus according to claim 1, wherein:
the vaporizing device vaporizes at least a portion of the water; and
the hydrocarbon fuel is a liquid, and the vapor mixing device sprays the hydrocarbon fuel.

3. A fuel reforming apparatus according to claim 2, wherein the vapor mixing device includes a spray devicethat controls a spray quantity of the hydrocarbon fuel.

4. A fuel reforming apparatus according to claim 3, wherein:
the vaporizing device is supplied with air;
the vaporizing device vaporizes the water and produces the vapor gas using the supplied air;
the vapor mixing device is supplied with a gas selected from the air and the vapor gas, via the spray device; and
the vapor mixing device creates the vapor mixture by spraying the hydrocarbon fuel with the spray device using the selected gas.

5. A fuel reforming apparatus according to claim 1, wherein the vapor mixing device includes a spray device that sprays and controls a spray quantity of the at least a portion of the at least one of the hydrocarbon fuel and the water.

6. A fuel reforming apparatus according to claim 5, wherein:
the vaporizing device is supplied with air;
the vaporizing device vaporizes the hydrocarbon fuel and produces the vapor gas using the air;
the vapor mixing device is supplied with a gas selected from the air and the vapor gas, via the spray device; and
the vapor mixing device creates the vapor mixture by spraying the water with the spray device using the selected gas.

7. A fuel reforming apparatus according to claim 5, wherein the spray device sprays a plurality of liquids, so as to spray at least a portion of both the hydrocarbon fuel and the water.

8. A fuel reforming apparatus according to claim 5, wherein the spray device includes a return member that returns a portion of the hydrocarbon fuel which is not vaporized to a supply, and a return quantity adjusting device that adjusts a quantity of the hydrocarbon fuel returned to the supply by the return member.

9. A fuel reforming apparatus according to claim 5, wherein the spray device uses a gas when spraying the at least a portion of the at least one of the htdrocarbon fuel and the water.

10. A fuel reforming apparatus according to claim 9, wherein the spray device uses at least a portion of the vapor gas produced by the vaporizing device as the gas.

11. A fuel reforming apparatus according to claim 5, wherein the spray device sprays the water.

12. A fuel reforming apparatus according to claim 1, wherein the vapor mixing device includes a vapor gas supply quantity adjusting device that adjusts a quantity of the vapor gas supplied by the vaporizing device to the vapor mixing device.

13. A fuel reforming apparatus according to claim 1, wherein the vapor mixing device includes an air supply quantity adjusting device that adjusts a quantity of the air supplied to the vapor mixing device.

14. A fuel reforming apparatus according to claim 1, further comprising a vapor spray quantity controller that controls a quantity of the one of the hydrocarbon fuel and the water supplied to the vaporizing device, and a quantity of the at least a portion of the at least one of the hydrocarbon fuel and the water supplied to the vapor mixing device.

15. A fuel reforming apparatus according to claim 14, wherein the vapor spray quantity controller controls a temperature of the vapor mixture supplied to the reforming device so that the vapor mixture falls within a predetermined temperature range.

16. A fuel reforming apparatus according to claim 15, wherein the predetermined temperature range contains a temperature that is below a lower limit of a regular operating temperature range of the reforming device by a predetermined amount.

17. A fuel reforming apparatus according to claim 1, wherein the vapor mixing device includes a mixture promoting member that promotes mixture of the vapor gas, a gas supplied to the vapor mixing device, and the sprayed liquid.

18. A fuel reforming apparatus according to claim 17, wherein:
the mixture promoting member is substantially conical with a through hole in a center thereof; and
the vapor mixing device includes the mixture promoting member and a supply port such that the supplied vapor gas and air are mixed and spurted out from the through hole, and sprays the at least a portion of the at least one of the hydrocarbon fuel and the water from the through hole of the mixture promoting member.

19. A fuel reforming apparatus according to claim 1, wherein the hydrocarbon fuel is gaseous, and the water is supplied to the vaporizing device.

20. A fuel reforming apparatus comprising:
a vaporizing device that vaporizes water and produces a vapor gas that includes the vaporized water and air;
a vapor mixing device, to which a gaseous hydrocarbon fuel is supplied, and that creates a mixed gas by spraying water using one selected from air, the vapor gas, and the gaseous hydrocarbon fuel, toward the supplied hydrocarbon fuel; and
a reforming device that receives the mixed gas from the vapor mixing device and reforms the gaseous hydrocarbon fuel to a reformate gas containing hydrogen.

21. A fuel reforming method comprising the steps of:
producing a vapor gas by vaporizing at least a portion of a first one of a hydrocarbon fuel and water, without mixing with a second one of the hydrocarbon fuel and the water, the vapor gas containing air and the vaporized first one of the hydrocarbon fuel and water;
creating a vapor mixture by spraying at least a portion of at least one of the hydrocarbon fuel and the water, which was not vaporized, toward the vapor gas; and
reforming the hydrocarbon fuel to a reformate gas containing hydrogen using the vapor mixture.

22. A method according to claim 21, wherein:
at least a portion of the water is vaporized; and
the hydrocarbon fuel is a liquid, and the hydrocarbon fuel issprayed in the creating step.

23. A method according to claim 22, wherein a spray quantity of the hydrocarbon fuel is controlled.

24. A method according to claim 21, wherein the hydrocarbon fuel is gaseous, and the water is vaporized.
